(19) United States
(12) Patent Application Publication
(10) Pub. No.: US 2026/0116489 A1
(43) Pub. Date: Apr. 30, 2026

(54) MOTORCYCLE

(71) Applicant: KAWASAKI MOTORS, LTD., Akashi-shi (JP)

(72) Inventors: Koki MIZOGUCHI, Akashi-shi (JP); Shinichi TANAKA, Akashi-shi (JP); Hiromasa WAKASHIMA, Akashi-shi (JP); Tomo YAMAMOTO, Akashi-shi (JP)

(21) Appl. No.: 19/373,299

(22) Filed: Oct. 29, 2025

(30) Foreign Application Priority Data
Oct. 29, 2024 (JP) 2024-189898

(51) Int. Cl. B62J 37/00; B62J 17/10; B62K 11/00

(52) U.S. Cl. CPC B62J 37/00; B62J 17/10; B62K 11/00

(57) ABSTRACT

There is provided a motorcycle including: a cowl disposed on an outer side of the motorcycle in a vehicle width direction; and a canister disposed on an inner side of the cowl in the vehicle width direction and having an air vent port. The cowl includes a guide portion that has an inclined surface inclined downward as the inclined surface extends in a specified direction below the air vent port to guide liquefied fuel leaked from the air vent port in the specified direction.

### CROSS-REFERENCE TO RELATED APPLICATIONS

This application is based on and claims priority under 35 USC 119 from Japanese Patent Application No. 2024-189898 filed on October 29, 2024, the contents of which are incorporated herein by reference.

### TECHNICAL FIELD

The present disclosure relates to a motorcycle.

### BACKGROUND ART

A motorcycle is known to include a canister that adsorbs and stores fuel vapor generated in a fuel tank (for example, see JP5798207B and JP6002707B). The canister includes an adsorbent that adsorbs the fuel vapor in a canister case, suctions the fuel vapor in the fuel tank from a suction port, adsorbs the fuel vapor with the adsorbent, and discharges the adsorbed fuel vapor from a discharge port to an intake passage of an engine during engine operation.

In the motorcycle, the canister is set to sufficiently adsorb the fuel vapor during normal use in accordance with gas vapor regulation or the like, but when excessive fuel vapor is adsorbed beyond a prescribed adsorption capacity, for example, the fuel vapor liquefies and then the liquefied fuel leaks from an air vent port of the canister case. If the liquefied fuel leaked from the air vent port adheres to an exhaust related component such as an exhaust pipe, an appearance or the like may be impaired.

### SUMMARY OF INVENTION

The present disclosure provides a motorcycle that prevents liquefied fuel leaked from an air vent port of a canister from adhering to an exhaust related component while preventing an increase in cost.

According to an illustrative aspect of the present disclosure, a motorcycle includes: a cowl disposed on an outer side of the motorcycle in a vehicle width direction; and a canister disposed on an inner side of the cowl in the vehicle width direction and having an air vent port. The cowl includes a guide portion that has an inclined surface inclined downward as the inclined surface extends in a specified direction below the air vent port to guide liquefied fuel leaked from the air vent port in the specified direction.

According to the present disclosure, the cowl of the motorcycle includes the guide portion that has the inclined surface, which is inclined downward as the inclined surface extends the specified direction below the air vent port to guide the liquefied fuel leaked from the air vent port of the canister in the specified direction. Even when the liquefied fuel leaks from the air vent port of the canister, the liquefied fuel can move to the predetermined discharge portion in the specified direction along the inclined surface of the guide portion, and thus the liquefied fuel leaked from the air vent port can be prevented from adhering to an exhaust related component such as the exhaust pipe. Since the cowl includes the guide portion, it is possible to prevent the liquefied fuel leaked from the air vent port of the canister from adhering to the exhaust related component while preventing an increase in cost without using a separate guide member.

### BRIEF DESCRIPTION OF DRAWINGS

FIG. 1 is a schematic side view of a motorcycle according to an embodiment of the present disclosure;

FIG. 2 is an outer side view of a side cowl;

FIG. 3 is an inner side view of the side cowl;

FIG. 4 illustrates a guide portion of the side cowl and a canister;

FIG. 5 illustrates a positional relationship between the guide portion and the canister of the motorcycle in an upright state; and

FIG. 6 illustrates the positional relationship between the guide portion and the canister of the motorcycle in an inclined state.

### DESCRIPTION OF EMBODIMENTS

Hereinafter, an embodiment of the present disclosure will be described with reference to the attached drawings.

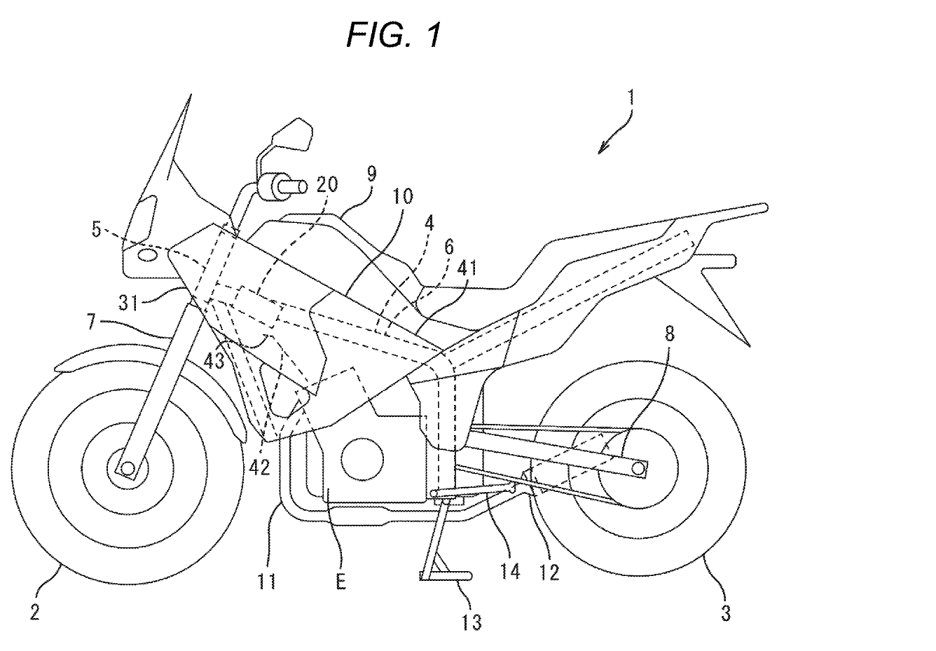

FIG. 1 is a schematic side view of a motorcycle according to the embodiment of the present disclosure. In the present specification, "front", "rear", "left", and "right" refer to a forward direction, a rearward direction, a leftward direction, and a rightward direction as viewed from a driver who rides on and drives a motorcycle.

As illustrated in FIG. 1, a motorcycle 1 according to the embodiment of the present disclosure includes a front wheel 2, a rear wheel 3, and a vehicle frame 4 disposed between the front wheel 2 and the rear wheel 3. The vehicle frame 4 includes a head pipe 5 extending substantially in an upper-lower direction and a main frame 6 extending rearward from the head pipe 5. The front wheel 2 is rotatably supported by a front fork 7 supported by the head pipe 5. The rear wheel 3 is rotatably supported by a swing arm 8 supported by the main frame 6.

To the vehicle frame 4, an engine E is attached. Above the engine E, a fuel tank 9 that stores gasoline as fuel to be supplied to the engine E is disposed. To the fuel tank 9, a canister 20 is connected. The canister 20 is disposed forward of the engine E and is attached to a side cowl 10.

To the engine E, air is supplied through an intake passage while fuel is supplied from the fuel tank 9. An exhaust pipe 11, which extends downward from forward of the engine E and then extends rearward, is connected to the engine E to discharge exhaust gas. A muffler 12 is disposed rearward of the exhaust pipe 11.

In the motorcycle 1, a center stand 13 is foldably supported on a lower portion of the vehicle frame 4. In the motorcycle 1 as illustrated in FIG. 1, the motorcycle is supported in an upright state with the center stand 13 unfolded. In the motorcycle 1, a side stand 14 is foldably supported on a vehicle left side of the lower portion of the vehicle frame 4. The motorcycle 1 is supported in an inclined state in which the motorcycle is inclined leftward with the side stand 14 unfolded.

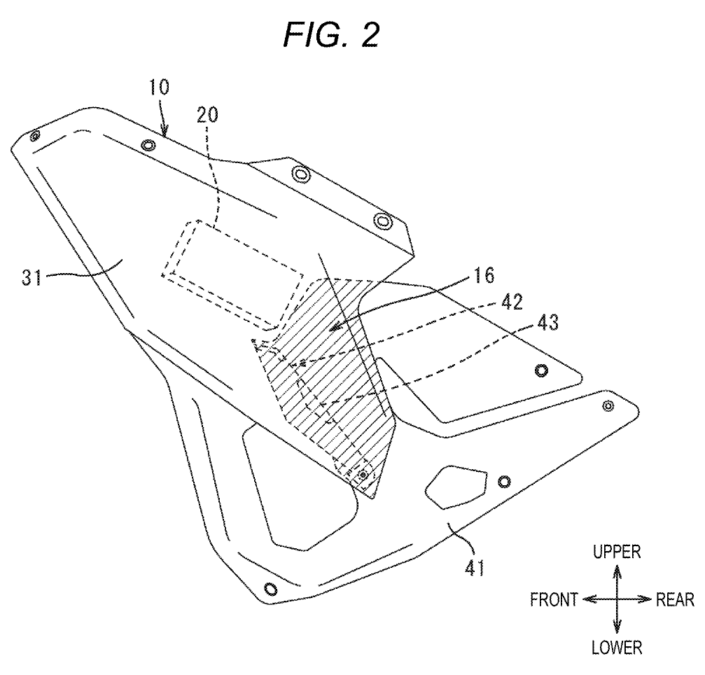

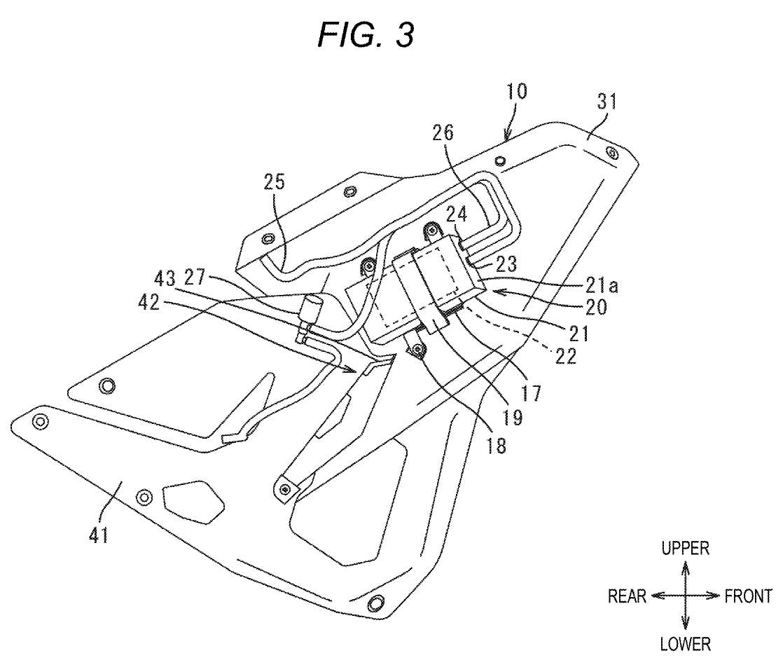

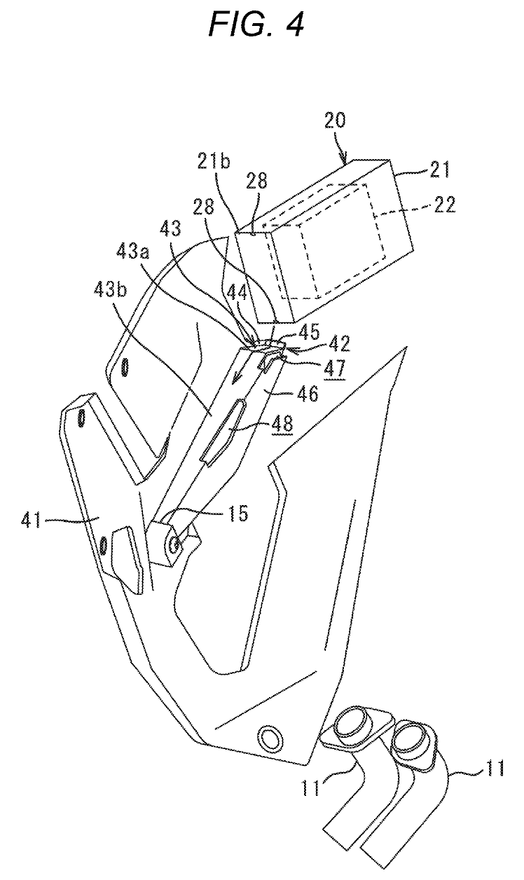

FIG. 2 is an outer side view of a side cowl. FIG. 3 is an inner side view of the side cowl. FIG. 4 illustrates a guide portion of the side cowl and a canister. FIG. 4 further illustrates the exhaust pipe 11.

As illustrated in FIG. 3, the canister 20 of the motorcycle 1 includes a canister case 21 having a substantially rectangular parallelepiped shape, and an adsorbent 22 that is disposed inside the canister case 21 and adsorbs fuel vapor, specifically, gasoline vapor, generated in the fuel tank 9. The canister 20 is inclined downward and rearward in a state where a longitudinal direction thereof is oriented in a front-rear direction of the motorcycle 1.

The canister case 21 has a suction port 23 and a discharge port 24 in a front end surface 21a. The suction port 23 and the discharge port 24 protrude from the canister case 21 in a substantially cylindrical shape. The suction port 23 is connected to the fuel tank 9 via a suction pipe 25. The discharge port 24 is connected to the intake passage of the engine E via a discharge pipe 26. In the discharge pipe 26, a control valve 27 that controls flow of the fuel vapor from the canister 20 to the engine is disposed.

The canister 20 suctions the fuel vapor in the fuel tank 9 from the suction port 23 through the suction pipe 25, adsorbs the fuel vapor by the adsorbent 22, and discharges the adsorbed fuel vapor from the discharge port 24 to the intake passage of the engine E through the discharge pipe 26 during engine operation.

As illustrated in FIG. 4, the canister case 21 is formed with, in a rear end surface 21b thereof, an air vent port 28 that penetrates the canister case 21 and makes inside of the canister case 21 communicate with outside thereof. The air vent port 28 is provided on a central side in a vehicle width direction on each of an upper side and a bottom side of the rear end surface 21b. When the excessive fuel vapor is adsorbed beyond a prescribed amount in the canister 20, for example, the air vent port 28 allows the liquefied fuel which is liquefied from the vapor fuel to leak to the outside. The air vent port 28 may be provided in another position of the rear end surface 21b of the canister case 21, or in another position of the canister case 21. The canister case 21 may have another shape such as a cylindrical shape.

As illustrated in FIG. 1, the side cowl 10 to which the canister 20 is attached extends in a direction substantially orthogonal to the vehicle width direction and is disposed on a left side of the motorcycle 1 in the vehicle width direction. The side cowl 10 is formed in a substantially triangular shape when viewed from an outer side in the vehicle width direction. As illustrated in FIG. 2, the side cowl 10 includes an outer cowl 31 disposed on the outer side in the vehicle width direction and an inner cowl 41 disposed inward of the outer cowl 31 in the vehicle width direction. The outer cowl 31 and the inner cowl 41 are attached to the vehicle frame 4 using fastening members. The outer cowl 31 and the inner cowl 41 are integrally formed as one component by an injection mold using a resin material.

The outer cowl 31 mainly constitutes front and upper sides of the side cowl 10, and the inner cowl 41 mainly constitutes rear and lower sides of the side cowl 10. The outer cowl 31 and the inner cowl 41 have, on a central side of the side cowl 10, an overlapping lap portion 16 (hatched portion) in the vehicle width direction. The inner cowl 41 is disposed inward of the outer cowl 31 in the vehicle width direction at the lap portion 16.

In the motorcycle 1, the canister 20 is attached to the outer cowl 31. As illustrated in FIG. 3, the canister case 21 of the canister 20 is supported on an inner side of the outer cowl 31 in the vehicle width direction by a canister bracket 17. The canister bracket 17 is fixed to the outer cowl 31 using a fastening member 18. The canister 20 is attached to the canister bracket 17 using a band member 19 in a state of being disposed on the canister bracket 17, and is supported on the outer cowl 31 by the canister bracket 17.

In the present embodiment as illustrated in FIG. 4, the inner cowl 41 includes a guide portion 42, which guides the liquefied fuel leaked from the air vent port 28 in a specified direction as indicated by an arrow in FIG. 4, corresponding to the canister 20, specifically, corresponding to the air vent port 28 of the canister case 21. The guide portion 42 is formed at the lap portion 16 of the inner cowl 41. The guide portion 42 has an inclined surface 43 inclined downward as the inclined surface 43 extends in a specified direction, specifically, the rearward direction, below the air vent port 28 of the canister 20. As illustrated in FIG. 4, the inclined surface 43 extends rearward of a front end portion of the exhaust pipe 11 in a position shifting from the exhaust pipe 11 in the vehicle width direction, specifically, outward of the exhaust pipe 11 in the vehicle width direction. In the present embodiment, a rear end portion of the inclined surface 43 is set as a predetermined discharge portion 15 of the liquefied fuel leaked from the air vent port 28.

The inclined surface 43 of the guide portion 42 has a substantially rectangular shape in a plan view and extends in the front-rear direction. The inclined surface 43 is inclined rearward and downward at a specified angle relative to a horizontal plane orthogonal to the upper-lower direction when the motorcycle 1 is in the upright state. The inclined surface 43 includes a first inclined surface 43a disposed below the air vent port 28 and inclined at a first angle θ1, and a second inclined surface 43b inclined at a second angle θ2 larger than the first angle θ1 rearward of the first inclined surface 43a. In the motorcycle 1 which is in the upright state, for example, 10 degrees is set as the first angle θ1, and for example, 50 degrees is set as the second angle θ2.

The guide portion 42 has an outer side surface 44 extending upward on an outer side of the inclined surface 43 in the vehicle width direction, a front side surface 45 extending upward on a front side of the inclined surface 43, and an inner side surface 46 extending downward from the inclined surface 43 on an inner side of the inclined surface 43 in the vehicle width direction.

The outer side surface 44 extends from the inclined surface 43 in a direction substantially orthogonal to an upper side along the outer side of the inclined surface 43 in the vehicle width direction. The outer side surface 44 is provided over the entire outer side of the first inclined surface 43a in the vehicle width direction and an entire outer side of the second inclined surface 43b in the vehicle width direction. The front side surface 45 extends along the front side of the inclined surface 43, specifically, along the front side of the first inclined surface 43a, from the inclined surface 43 in a direction substantially orthogonal to the upper side. The inner side surface 46 extends from the inclined surface 43 in a direction substantially orthogonal to a lower side along the inner side of the inclined surface 43 in the vehicle width direction. The inner side surface 46 is provided over the inner side of the first inclined surface 43a in the vehicle width direction and an inner side of the second inclined surface 43b in the vehicle width direction.

The guide portion 42 is formed with a hole 47 between an upper portion of the inclined surface 43 and the inner side surface 46. The first hole 47 is formed between the first inclined surface 43a, which is the upper portion of the inclined surface 43, and the inner side surface 46. The first hole 47 is formed by cutting a corner portion between the inner side surface 46 and the inner side of the first inclined surface 43a in the vehicle width direction and cutting a corner portion between the inner side surface 46 and an upper portion of the second inclined surface 43b, and has a hole shape elongated in the front-rear direction. With the hole 47, when the liquefied fuel leaked from the air vent port 28 moves to an inner side in the vehicle width direction, the liquefied fuel moves downward along an outer side of the inner side surface 46 in the vehicle width direction, and is thus prevented from moving to the inner side in the vehicle width direction. Since the guide portion 42 is formed at a portion of the inner cowl 41 that overlaps the outer cowl 31, the liquefied fuel moved from the hole 47 along the outer side of the inner side surface 46 in the vehicle width direction is prevented from being visually recognized from outside.

The guide portion 42 is further formed with a hole 48 between a central portion of the inclined surface 43 and the inner side surface 46. The second hole 48 is formed between a central portion of the second inclined surface 43b in the upper-lower direction, which is a central portion of the inclined surface 43, and the inner side surface 46. The second hole 48 is formed by cutting a corner portion between the central portion of the second inclined surface 43b and the inner side surface 46, and has a hole shape elongated in the front-rear direction. The hole 48 also prevents the liquefied fuel from moving to the inner side in the vehicle width direction.

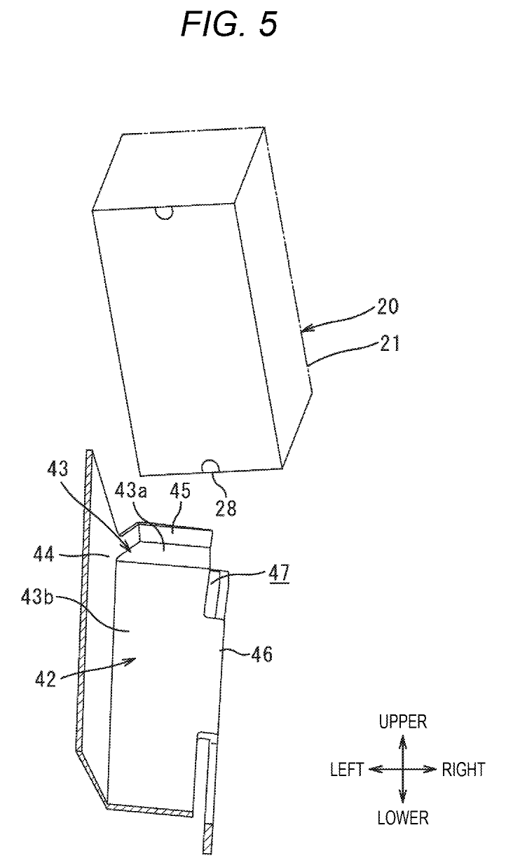

FIG. 5 illustrates a positional relationship between the guide portion and the canister of the motorcycle in the upright state. As illustrated in FIG. 5, the inclined surface 43 of the guide portion 42, specifically, the first inclined surface 43a, is disposed at a position overlapping the air vent port 28 of the canister 20 in the vehicle width direction and the front-rear direction when the motorcycle 1 is in the upright state of being supported by the center stand 13.

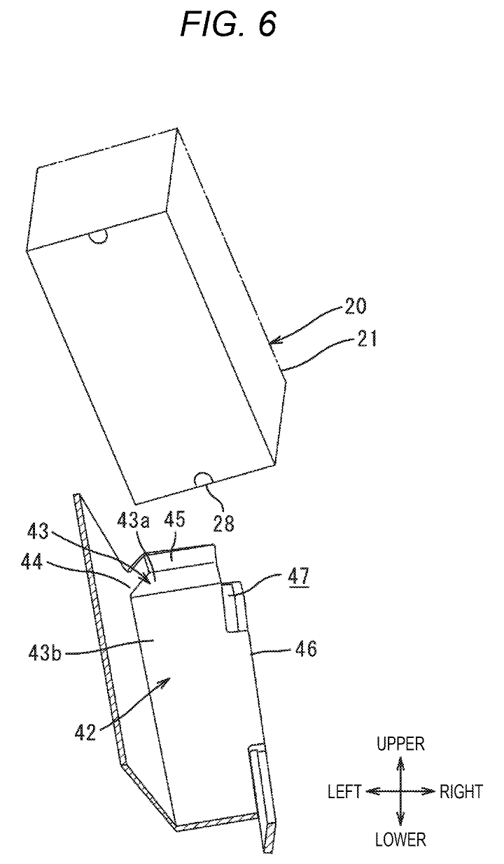

FIG. 6 illustrates the positional relationship between the guide portion and the canister of the motorcycle in the inclined state. As illustrated in FIG. 6, the inclined surface 43 of the guide portion 42, specifically, the first inclined surface 43a is disposed at the position overlapping the air vent port 28 of the canister 20 in the vehicle width direction and the front-rear direction when the motorcycle 1 is in the inclined state of being supported by the side stand 14.

The guide portion 42 is disposed at a position where the inclined surface 43 overlaps the air vent port 28 in the vehicle width direction and the front-rear direction when the motorcycle 1 is in the upright state and the inclined state. When the motorcycle stops traveling, in which the liquefied fuel may leak from the air vent port 28 of the canister 20, and the liquefied fuel leaks from the air vent port 28, the guide portion 42 receives the liquefied fuel and guides the liquefied fuel to a rear portion of the guide portion 42 while preventing the liquefied fuel from coming into contact with an exhaust related component such as the exhaust pipe 11 that is a high-temperature component. Even when the liquefied fuel leaked from the air vent port 28 moves to an outer side in the vehicle width direction of a lower side of the rear end surface 21b, which is a lowermost portion of the canister case 21, and then drips downward, the liquefied fuel is received by the guide portion 42 and guided to the rear portion of the guide portion 42. The rear portion of the guide portion 42 functions as the predetermined discharge portion 15, and the liquefied fuel may substantially evaporate before moving to the rear portion of the guide portion 42 when gasoline is used as the fuel.

The guide portion 42 may be formed by one inclined surface inclined downward and rearward at a specified inclination angle. Instead of the inclined surface 43 having a specified inclination angle, the guide portion 42 may have an inclined surface inclined downward and rearward at various inclination angles. The guide portion 42 may not have the front side surface 45. The guide portion 42 may not have at least one of the first hole 47 and the second hole 48.

The side cowl 10 may be formed by a single component, and the canister 20 may be attached to the side cowl 10 and the guide portion 42 may be provided on the side cowl 10. The canister 20 is preferably attached to the side cowl 10, and may also be attached to another member such as the vehicle frame 4. The guide portion 42 is provided on the side cowl 10, and may also be provided on another cowl such as a portion disposed on an outer side of a front cowl in the vehicle width direction. The guide portion 42 has the inclined surface 43 inclined downward and rearward, and the guide portion 42 may have an inclined surface that is inclined downward as the inclined surface extends in a specified direction such as a direction away from the air vent port 28 and guide the liquefied fuel leaked from the air vent port 28 in the specified direction.

In this manner, the motorcycle 1 according to the present embodiment includes the cowl 10 disposed on the outer side in the vehicle width direction and the canister 20 that is disposed on the inner side of the cowl 10 in the vehicle width direction and has the air vent port 28. The cowl 10 includes the guide portion 42 that has the inclined surface 43, which is inclined downward as the inclined surface 43 extends in a specified direction below the air vent port 28, to guide the liquefied fuel leaked from the air vent port 28 in the specified direction.

The cowl 10 includes the guide portion 42 that has the inclined surface 43, which is inclined downward as the inclined surface 43 extends in the specified direction below the air vent port 28, to guide the liquefied fuel leaked from the air vent port 28 of the canister 20 in the specified direction. Accordingly, even when the liquefied fuel leaks from the air vent port 28, the liquefied fuel can move to the predetermined discharge portion in the specified direction along the inclined surface 43 of the guide portion 42, and thus the liquefied fuel leaked from the air vent port 28 can be prevented from adhering to an exhaust related component such as the exhaust pipe 11. Since the cowl 10 includes the guide portion 42, it is possible to prevent the liquefied fuel leaked from the air vent port 28 from adhering to the exhaust related component 11 while preventing an increase in cost without using a separate guide member.

The guide portion 42 may have the outer side surface 44 extending upward on the outer side of the inclined surface 43 in the vehicle width direction. Accordingly, when the liquefied fuel leaks from the air vent port 28 in a state in which the motorcycle 1 is held in the inclined state by the side stand 14, the liquefied fuel can move rearward along the outer side surface on the inclined surface 43 of the guide portion 42.

The guide portion 42 may have the front side surface 45 extending upward on the front side of the inclined surface 43. Accordingly, the liquefied fuel leaked from the air vent port 28 can be prevented from moving to the front side of the guide portion 42 and move in the specified direction.

The canister 20 may be attached to the inner side of the cowl 10 in the vehicle width direction. Accordingly, since the canister 20 is attached to the cowl 10 including the guide portion 42, the inclined surface 43 of the guide portion 42 can be accurately disposed below the air vent port 28 of the canister 20.

The inclined surface 43 may have the first inclined surface 43a inclined downward and rearward and inclined at a first angle below the air vent port 28, and the second inclined surface 43b inclined at a second angle larger than the first angle rearward of the first inclined surface 43a. Accordingly, as compared with a case where the inclined surface 43 has a constant angle, the liquefied fuel leaked from the air vent port 28 can be effectively received by the first inclined surface 43a disposed in a vicinity of the air vent port 28 of the canister 20 and easily guided to the predetermined discharge portion by the second inclined surface 43b.

The cowl 10 may include the outer cowl 31 disposed on the outer side in the vehicle width direction, and the inner cowl 41 disposed inward of the outer cowl 31 in the vehicle width direction with at least a part thereof overlapping the outer cowl 31. The guide portion 42 may include the inner side surface 46 extending downward from the inclined surface 43 on the inner side of the inclined surface 43 in the vehicle width direction and the hole 47 formed between the upper portion of the inclined surface 43 and the inner side surface 46, and may be formed at a portion that overlaps the outer cowl 31 on the inner cowl 41.

Accordingly, when the liquefied fuel leaks from the air vent port 28 in a state in which the motorcycle 1 is held in the upright state by the center stand 13, even when the liquefied fuel moves to the inner side in the vehicle width direction at the upper portion of the inclined surface 43 of the guide portion 42, the liquefied fuel can move along the outer side of the inner side surface 46 in the vehicle width direction from the hole 47 and be prevented from adhering to the exhaust related component 11. Even when the liquefied fuel moves along the outer side of the inner side surface 46 in the vehicle width direction from the hole 47, it is possible to prevent the liquefied fuel from being visually recognized from the outside and prevent an appearance from being impaired since the guide portion 42 is formed at the portion of the inner cowl 41 that overlaps the outer cowl 31. It is not necessary to use a slide die as in a case of molding an inner cowl including a guide portion having an inner side surface extending upward on the inner side of the inclined surface 43 in the vehicle width direction, and the inner cowl 41 including the guide portion 42 can be molded using a pair of molding dies.

The inclined surface 43 may be disposed at a position overlapping the air vent port 28 in the vehicle width direction and the front-rear direction when the motorcycle 1 is in the upright state and the inclined state. Accordingly, when the liquefied fuel leaks from the air vent port 28 in the state where the motorcycle 1 is held in the upright state and the inclined state, the liquefied fuel leaked from the air vent port 28 can be effectively received by the inclined surface 43 and move to the predetermined discharge portion.

The inclined surface 43 may extend rearward of the front end portion of the exhaust pipe 11 in a position shifting from the exhaust pipe 11 in the vehicle width direction. Accordingly, it is possible to prevent the liquefied fuel leaked from the air vent port 28 of the canister 20 from dripping to the exhaust pipe 11.

The present disclosure is not limited to the described embodiment, and various improvements and design changes can be made without departing from the gist of the present disclosure.

### Appendix 1

A motorcycle includes:

a cowl disposed on an outer side of the motorcycle in a vehicle width direction; and

a canister disposed on an inner side of the cowl in the vehicle width direction and having an air vent port, in which

the cowl includes a guide portion that has an inclined surface inclined downward as the inclined surface extends in a specified direction below the air vent port to guide liquefied fuel leaked from the air vent port in the specified direction.

### Appendix 2

In the motorcycle according to Appendix 1,

the guide portion has an outer side surface extending upward on an outer side of the inclined surface in the vehicle width direction.

### Appendix 3

In the motorcycle according to Appendix 1 or 2,

the guide portion has a front side surface extending upward on a front side of the inclined surface.

### Appendix 4

In the motorcycle according to any one of Appendixes 1 to 3,

the canister is attached to the inner side of the cowl in the vehicle width direction.

### Appendix 5

In the motorcycle according to any one of Appendixes 1 to 4,

the inclined surface includes:

a first inclined surface inclined downward and rearward, the first inclined surface being inclined at a first angle below the air vent port; and

a second inclined surface inclined at a second angle larger than the first angle rearward of the first inclined surface.

### Appendix 6

In the motorcycle according to any one of Appendixes 1 to 5,

the cowl includes:

an outer cowl disposed on an outer side in the vehicle width direction; and

an inner cowl disposed on an inner side of the outer cowl in the vehicle width direction with at least a part of the inner cowl overlapping the outer cowl, and

the guide portion includes:

an inner side surface extending downward from the inclined surface on an inner side of the inclined surface in the vehicle width direction; and

a hole formed between an upper portion of the inclined surface and the inner side surface, and

the hole is formed at a portion that overlaps the outer cowl on the inner cowl.

### Appendix 7

In the motorcycle according to any one of Appendixes 1 to 6,

the inclined surface is disposed at a position overlapping the air vent port in the vehicle width direction and a front-rear direction when the motorcycle is in an upright state and an inclined state.

### Appendix 8

In the motorcycle according to any one of Appendixes 1 to 7,

the inclined surface extends rearward of a front end portion of the exhaust pipe in a position shifting from the exhaust pipe in the vehicle width direction.

What is claimed is:

1. A motorcycle comprising:
a cowl disposed on an outer side of the motorcycle in a vehicle width direction; and
a canister disposed on an inner side of the cowl in the vehicle width direction and having an air vent port, wherein
the cowl includes a guide portion that has an inclined surface inclined downward as the inclined surface extends in a specified direction below the air vent port to guide liquefied fuel leaked from the air vent port in the specified direction.

2. The motorcycle according to claim 1, wherein
the guide portion has an outer side surface extending upward on an outer side of the inclined surface in the vehicle width direction.

3. The motorcycle according to claim 1, wherein
the guide portion has a front side surface extending upward on a front side of the inclined surface.

4. The motorcycle according to claim 1, wherein
the canister is attached to the inner side of the cowl in the vehicle width direction.

5. The motorcycle according to claim 1, wherein
the inclined surface includes:
a first inclined surface inclined downward and rearward, the first inclined surface being inclined at a first angle below the air vent port; and
a second inclined surface inclined at a second angle larger than the first angle rearward of the first inclined surface.

6. The motorcycle according to claim 1, wherein
the cowl includes:
an outer cowl disposed on an outer side in the vehicle width direction; and
an inner cowl disposed on an inner side of the outer cowl in the vehicle width direction with at least a part of the inner cowl overlapping the outer cowl,
the guide portion includes:
an inner side surface extending downward from the inclined surface on an inner side of the inclined surface in the vehicle width direction; and
a hole formed between an upper portion of the inclined surface and the inner side surface, and
the hole is formed at a portion that overlaps the outer cowl on the inner cowl.

7. The motorcycle according to claim 1, wherein
the inclined surface is disposed at a position overlapping the air vent port in the vehicle width direction and a front-rear direction when the motorcycle is in an upright state and an inclined state.

8. The motorcycle according to claim 1, wherein
the inclined surface extends rearward of a front end portion of the exhaust pipe in a position shifting from the exhaust pipe in the vehicle width direction.
